(19) United States
(12) Patent Application Publication
(10) Pub. No.: US 2009/0206977 A1
(43) Pub. Date: Aug. 20, 2009

(54) Thermal overload relay

(75) Inventors: Yukinari Furuhata, Konosu-shi (JP); Fumihiro Morishita, Saitama (JP); Takeo Kamosaki, Saitama (JP)

Correspondence Address: KANESAKA BERNER AND PARTNERS LLP, 1700 DIAGONAL RD, SUITE 310, ALEXANDRIA, VA, 22314-2848, US

(73) Assignee: FUJI ELECTRIC FA COMPONENTS & SYSTEMS CO., LTD., Tokyo (JP)

(21) Appl. No.: 12/318,467

(22) Filed: Dec. 30, 2008

(30) Foreign Application Priority Data
Feb. 19, 2008 (JP) 2008-037106
Oct. 6, 2008 (JP) 2008-259294

(51) Int. Cl. H01H 61/00

(52) U.S. Cl. 337/37

(57) ABSTRACT

A thermal overload relay is provided with an external case, and an adjustment dial with a cam inserted into an adjustment dial insertion hole provided in the external case for adjusting a settling current. A press-fitting section is provided at one of the adjustment dial and the adjustment dial insertion hole, and a locking section is provided at the other of the adjustment dial and the adjustment dial insertion hole. The press-fitting section is press-fit and retained in the locking section.

### BACKGROUND OF THE INVENTION AND RELATE ART STATEMENT

The present invention relates to a thermal overload relay (thermal relay) used in combination with an electromagnetic contactor and the like, and more particularly, to a retaining structure of an adjustment dial thereof.

An explanation is first provided for a conventional structure of the above-mentioned thermal overload relay with reference to FIG. 12. In FIG. 12, reference symbol 1 indicates a molded plastic external case, 2 a main bimetal that is bent by heat generated by a heater connected to a main circuit, 3 a shifter coupled to the free end of the main bimetal 2, 4 a releasing lever driven by displacement of the shifter 3, 5 an inversion operation mechanism for opening or closing a contact, 6 a normally closed contact comprising a movable contact 6a and a fixed contact 6b, 7 a normally open contact comprising a fixed contact 7a and a movable contact 7b provided on a movable contact shoe piece, 8 an adjustment link having a lower end supported in a case slot 1a provided in the external case 1 and being coupled to a proximal end of the releasing lever 4 at a support point 4a, and 9 an adjustment dial comprising a head section 9c (FIG. 13) and a shaft section 9g and having a cam surface 9a on the lower end of the shaft section 9g, an upper end 8a of the adjustment link 8 contacting the cam surface 9a.

Furthermore, a current adjustment hole 9d is a hole for inserting a screwdriver for adjusting settling current, and current setting scale 9e is a scale for aligning with an indicated value provided on the external case 1. Here, the inversion operation mechanism 5 comprises a pivotally movable plate 11 having one end locked and supported in a V-shaped groove 10a of a generally U-shaped support piece 10, a tension spring 12 extending between a distal end section 11a of the movable plate 11 and a spring catching section 10b of the support piece 10, and a normally open contact drive lever 13 protruding towards the back from the movable plate 11 in the shape of the letter L, and the movable contact 6a of the normally closed contact 6 is attached to the distal end section of the movable plate 11. In addition, the fixed contact 6b of the normally closed contact 6 has one end fixed to the bottom of the external case 1 and is attached to a contact supporting piece 14 having a flat spring structure lying in the horizontal direction.

The tension spring 12 has a coil-like spring section 12a formed of a wire of a spring steel material and a protruding section 12b formed to protrude into the center of the tensile spring 12, and has hook sections formed on both ends thereof. With this configuration, in the steady state shown in FIG. 12, the movable plate 11 of the inversion operation mechanism 5 tilts in the clockwise direction from its neutral position due to spring force applied from the tension spring 12, and the movable contact 6a of the normally closed contact 6 presses against the fixed contact 6b to maintain the contact in the “on” state. Furthermore, the normally open contact 7 is “off” in this state.

Here, when an overload current flows through a main circuit, the main bimetal 2 is heated and bent, and the shifter 3 moves to the right due to displacement of the free end thereof. As a result, releasing lever 4 pivots around a support point 4a. At this time, in addition to the projecting section 12b of the tension spring 12 of the inversion operation mechanism 5 being pushed upward, when the displacement of the tension spring 12 exceeds a dead point of the movable plate 11, the movable plate 11 is rapidly driven to be inverted, and together with the movable contact 6a of the normally closed contact 6 separating from the fixed contact 6b, a movable contact show piece to which movable contact 7b is attached is pressed by the drive lever 13, and the movable contact 7b contacts the fixed contact 7a to turn on the contact (see, for example, Patent document 1).

Next, an explanation is provided for a method for adjusting a settling current value of a thermal overload relay based on FIG. 12. In FIG. 12, when the adjustment dial 9 is rotated, the adjustment link 8, having the upper end 8a contacting the cam surface 9a, is displaced by using the case slot 1a of the external case 1 as a support point. Accompanying this, the releasing lever 4 coupled to the adjustment link 8 can be displaced and moved to change the gap between the releasing lever 4 and a distal end of the shifter 3.

Here, an explanation is provided for a method of retaining the adjusting dial 9 in an adjustment dial insertion hole 1b provided in the external case 1 based on FIG. 13. In FIG. 13, in order to retain the adjustment dial 9 at a prescribed incorporated position, a wire spring 15, obtained by bending a spring wire material (such as a piano wire) to a shape like that shown in FIG. 13, is disposed as shown in FIG. 10, and the adjustment dial 9 is pressed and held at a fixed position by the spring reaction force thereof. In addition, Patent document 2 discloses a configuration in which an adjustment dial is retained by a handle linking bracket and a pressing spring.

Patent document 1: Japanese Patent Application Laid-open No. 2001-160346, corresponding U.S. Pat. No. 6,459,355 B1

Patent document 2: Japanese Utility Model Application Laid-open No. S53-95168

However, in a thermal overload relay of the prior art as described above, a wire spring 15 or other part is required to retain the adjustment dial 9 at a fixed position, thereby resulting in the problems of increasing the number of parts and number of assembly steps during product assembly as well as increasing costs.

With the foregoing, an object of the present invention is to provide a thermal overload relay having an improved structure for retaining the adjustment dial 9 so as to enable the adjustment dial 9 to be stably retained in the external case 1 without increasing the number of parts.

Further objects and advantages of the invention will be apparent from the following description of the invention.

### SUMMARY OF THE INVENTION

In order to achieve the above-mentioned object, according to the present invention, in a thermal overload relay provided with an external case, and an adjustment dial with a cam that is inserted into an adjustment dial insertion hole provided in the external case and that adjusts a settling current, a press-fitting section is provided in one of the adjustment dial and the adjustment dial insertion hole, and a locking section in which the press-fitting section is press-fit and retained is provided in the other (the first aspect). In addition, the thermal overload relay can be configured in the specific modes described below.

(1) The press-fitting section is provided on the adjustment dial, and the locking section is provided in the adjustment dial insertion hole of the external case (the second aspect).

(2) The press-fitting section provided on the adjustment dial is provided with a projection on the outer periphery of the adjustment dial that contacts the locking section of the adjustment dial insertion hole of the external case (the third aspect).

(3) The locking section provided on the case is in the form of a chambered section (inclined section) (the forth aspect).

(4) The projection provided on the outer periphery of the adjustment dial is provided around the entire periphery (the fifth aspect).

(5) The projection of the press-fitting section provided on the adjustment dial is provided at three locations or more at equal intervals on the outer periphery thereof (the sixth aspect).

(6) The adjustment dial insertion hole has a triangular shape, and an adjustment dial contact surface of the adjustment dial insertion hole is in the form of a locking section provided on the external case (the seventh aspect).

(7) A shaft section of the adjustment dial is of a size sufficient to contact the adjustment dial contact surface so that the shaft section contacts the adjustment dial contact surface (the eighth aspect).

According to the above-mentioned configuration, although a spring member or other parts were used to retain an adjustment dial in the prior art, since the adjustment dial can be stably retained at a fixed position with the adjustment dial alone, the number of parts and number of assembly steps are decreased and costs are reduced.

### BRIEF DESCRIPTION OF THE DRAWINGS

FIG. 1 is a frontal view showing an adjustment dial indicating an embodiment of the present invention.

FIG. 2 is a perspective view of the adjustment dial shown in FIG. 1.

FIG. 3 is an enlarged view of the press-fitting section of the adjustment dial shown in FIG. 2.

FIG. 4 is a cross-sectional view showing the adjustment dial incorporated in an embodiment of the present invention.

FIG. 5 is an enlarged view showing the press-fitting section of the adjustment dial shown in FIG. 4 engaged with a locking section of an external case.

FIG. 6 is a cross-sectional view of an adjustment dial indicating a second embodiment of the present invention.

FIG. 7 is a cross-sectional view of an adjustment dial indicating a third embodiment of the present invention.

FIG. 8 is a perspective view of an adjustment dial indicating a fourth embodiment of the present invention.

FIG. 9 is a perspective view of an adjustment dial showing a fifth embodiment of the present invention.

FIG. 10A is a perspective view and FIG. 10B is a cross-sectional view of an external case showing a fifth embodiment of the present invention.

FIG. 11 is a cross-sectional view showing the adjustment dial shown in FIGS. 9, 10A and 10B engaged with the external case.

FIG. 12 is an internal structural drawing of a thermal overload relay indicating an example of the prior art.

FIG. 13 is a perspective view showing a method of fixing an adjustment dial indicating an example of the prior art.

### DETAILED DESCRIPTION OF PREFERRED EMBODIMENTS

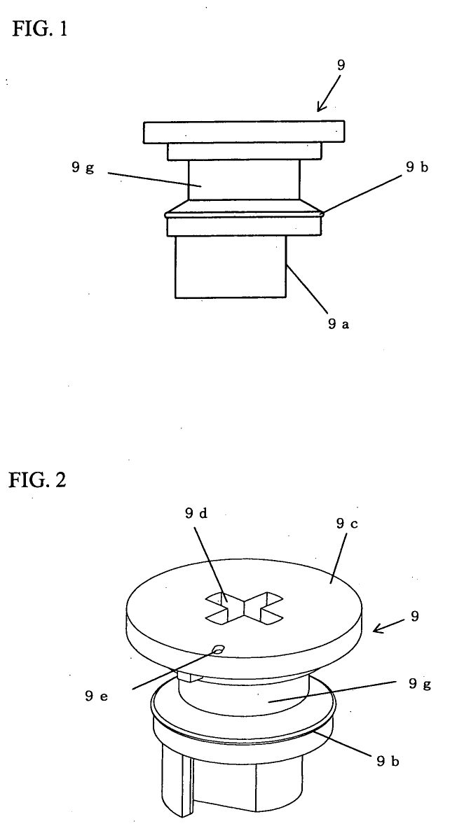

The following provides an explanation of a specific mode for carrying out the present invention based on the embodiments shown in FIGS. 1 to 11.

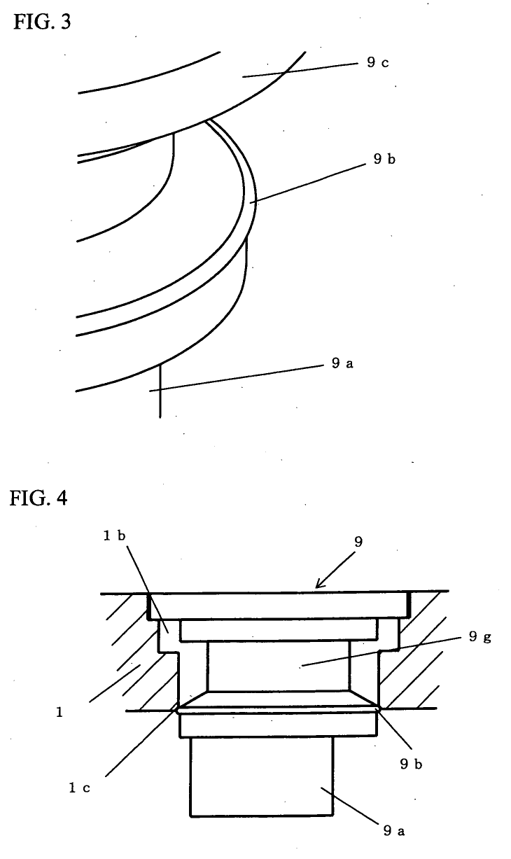

FIG. 1 is a front view showing an adjustment dial of a thermal overload relay of the present invention, FIG. 2 is a perspective view of the adjustment dial shown in FIG. 1, and FIG. 3 is an enlarged view of the press-fitting section (projection) shown in FIG. 2.

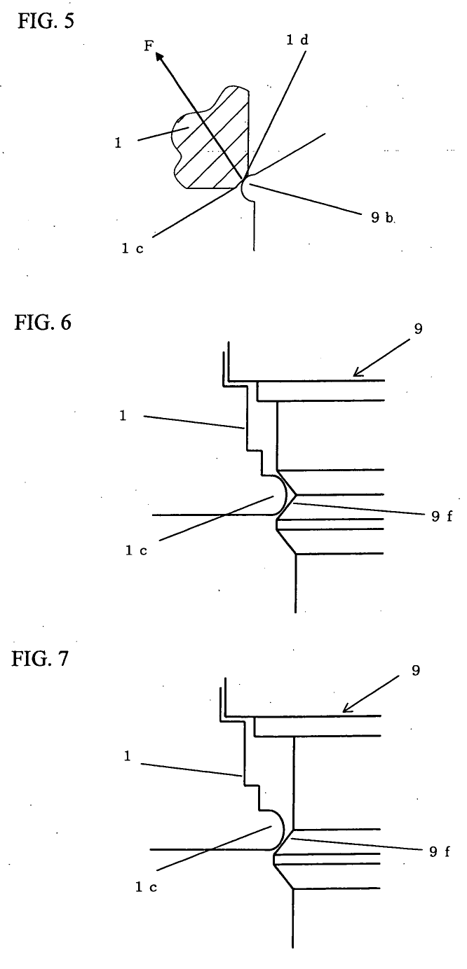

FIG. 4 is a cross-sectional view showing an adjustment dial of the present invention press-fit and retained in an adjustment dial insertion hole provided in an external case, and FIG. 5 is an enlarged view of the press-fitting section of the adjustment dial shown in FIG. 4 engaged with the external case.

Namely, in the embodiment shown in the drawings, the press-fitting section 9b comprising a projection so as to protrude from the outer periphery is provided on the outer periphery of shaft section 9g of adjustment dial 9, and a locking section 1c in which the press-fitting section 9b is press-fit and retained is provided on the lower end of an adjustment dial insertion hole 1b. Furthermore, during adjustment of settling current, settling current is adjusted by inserting a screwdriver into a current adjustment hole 9d provided in a head section 9c of adjustment dial 9 and rotating adjustment dial 9. In addition, the screwdriver is rotated so as to align a current settling scale 9e provided on head section 9c of adjustment dial 9 for representing a settling current set value with an indicated value not shown provided on external case 1.

As shown in FIG. 4, adjustment dial 9 is inserted into adjustment dial insertion hole 1b of external case 1 by press fitting a press-fitting section 9b provided on the outer periphery of adjustment dial 9 into adjustment dial insertion hole 1b provided in external case 1. At that time, together with the press-fitting section 9b being press-fit and retained by the lower end of adjustment dial insertion hole 1b, adjustment dial 9 can be prevented from coming out. Since, as shown in FIG. 5, the press-fit and retained press-fitting section 9b of adjustment dial 9 generates force in the direction of F with respect to locking section 1c, adjustment dial 9 can be stably retained at a fixed position without becoming loose. In addition, as shown in FIG. 5, forming a chambered section (inclined section) 1d on locking section 1c of external case 1 facilitates insertion of adjustment dial 9 into adjustment dial insertion hole 1b.

In addition, FIGS. 6 and 7 indicate other embodiments of the present invention. FIGS. 6 and 7 are cross-sectional views showing the incorporated state of an adjustment dial press-fit and retained in an adjustment dial insertion hole provided in an external case.

Although a press-fit section 9b is provided on the outer periphery of adjustment dial 9 and a locking section 1c is provided on the lower end of adjustment dial insertion hole 1b provided in external case 1 in the previously described embodiment, as shown in FIGS. 6 and 7, a press-fitting section similar to press-fitting section 9b of adjustment dial 9 may be provided on for locking section 1c on the lower end of adjustment dial insertion hole 1b provided in external case 1, and locking section 9f may be provided on adjustment dial 9.

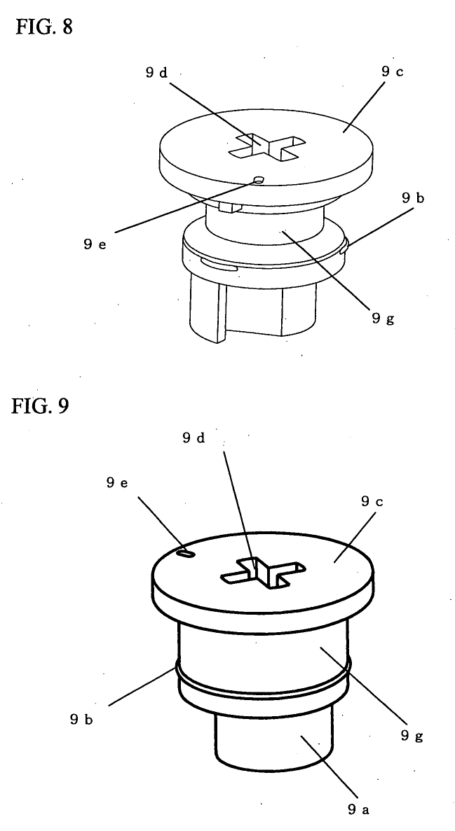

FIG. 8 shows an adjustment dial 9 indicating another embodiment of the present invention, and in this embodiment, three or more press-fitting sections 9b are provided on the outer periphery of adjustment dial 9, thereby facilitating press fitting of adjustment dial 9 into adjustment dial insertion hole 1b provided in external case 1. Furthermore, the method for press fitting adjustment dial 9 into adjustment dial insertion hole 1b of external case 1 is the same as that of the embodiment of FIG. 4.

FIGS. 9 to 11 show another embodiment of the present invention.

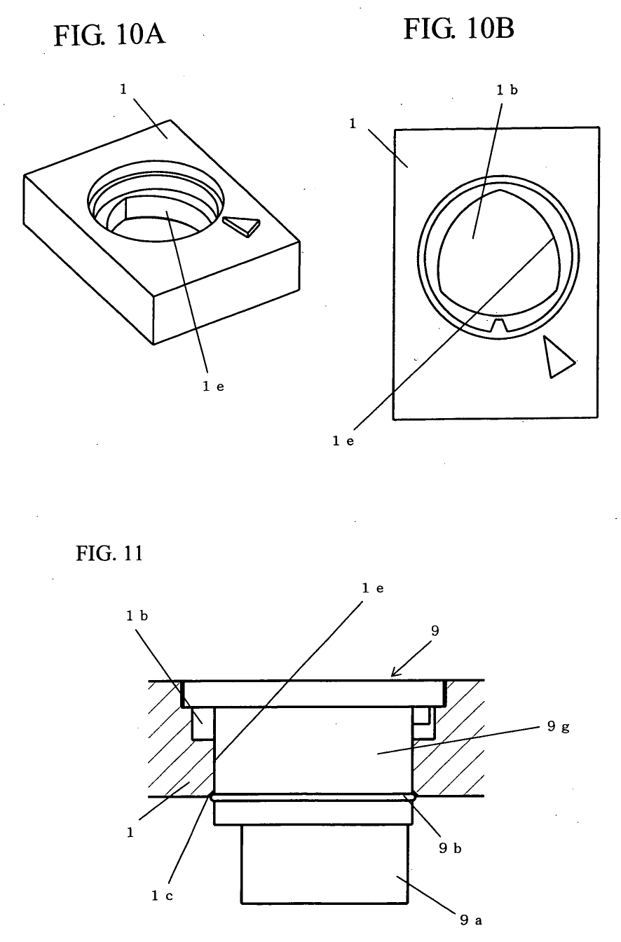

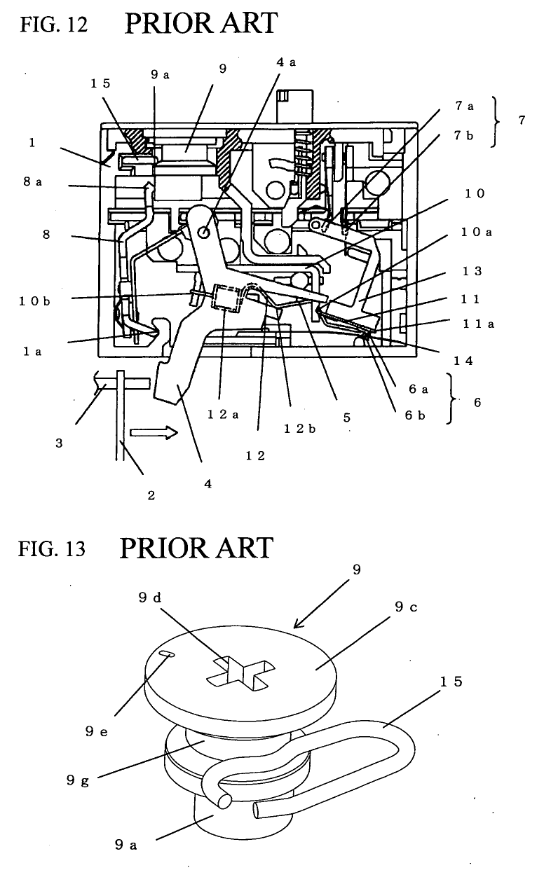

FIG. 9 is a perspective view of an adjustment dial showing another embodiment of the present invention, FIG. 10A is a perspective view of an external case showing another embodiment thereof, FIG. 10B is an overhead view of the external case shown in FIG. 10A, and FIG. 11 is a cross-sectional view showing an adjustment dial indicating another embodiment of the present invention press-fit and retained in an adjustment dial insertion hole provided in an external case.

Namely, in the embodiment shown in the drawings, the press-fitting section 9b comprising a projection so as to protrude from the outer periphery is provided on the outer periphery of the shaft section 9g of adjustment dial 9. Here, the shaft section 9g of the adjustment dial 9 shown in FIG. 9 may have a smaller diameter dimension in the manner of the shaft section 9g of the adjustment dial 9 shown in FIG. 1, or may have the same diameter dimension as the head section 9c of the adjustment dial 9. In addition, in the adjustment dial insertion hole 1b of the external case 1 shown in FIGS. 10A and 10B, the hole of an adjustment dial contact surface 1e where the shaft section 9g of the adjustment dial 9 contacts the external case 1 has a triangular shape having a circular arc. Incidentally, the shape of the hole of the adjustment dial contact surface 1e of the adjustment dial insertion hole is limited to a triangular shape in the present embodiment, but a polygonal insertion hole may also be employed.

As shown in FIG. 11, the adjustment dial 9 is press-fit into the adjustment dial contact surface 1e in which the adjustment dial insertion hole 1b provided in the external case 1 is in the form of a triangular hole by inserting the press-fitting section 9b of the adjustment dial 9 into the adjustment dial insertion hole 1b provided in the external case 1. At that time, together with the press-fitting section 9b being press-fit and retained by the lower end of the adjustment dial contact surface 1e of the adjustment dial insertion hole 1b, the adjustment dial 9 can be prevented from coming out. As a result, the adjustment dial 9 is retained at three points, and can be stably retained at a fixed position without becoming loose. In addition, since the shaft section 9g of the adjustment dial 9 contacts the adjustment dial contact surface in which the adjustment dial insertion hole 1b provided in the external case 1 is in the form of a triangular hole, frictional resistance increases thereby also demonstrating the effect of preventing erroneous rotation of the adjustment dial 9.

The disclosures of Japanese Patent Applications No. 2008-37106 filed on Feb. 19, 2008 and No. 2008-259294 filed on Oct. 6, 2008 are incorporated as reference.

While the invention has been explained with references to the specific embodiments of the invention, the explanation is illustrative and the invention is limited only by the appended claims.

What is claimed is:

1. A thermal overload relay, comprising:
an external case having an adjustment dial insertion hole,
an adjustment dial with a cam inserted into the adjustment dial insertion hole for adjusting a settling current,
a press-fitting section provided at one of the adjustment dial and the adjustment dial insertion hole, and
a locking section provided at the other of the adjustment dial and the adjustment dial insertion hole, said press-fitting section being press-fit and retained at the locking section.

2. The thermal overload relay according to claim 1, wherein the press-fitting section is provided on the adjustment dial, and the locking section is provided around the adjustment dial insertion hole of the external case.

3. The thermal overload relay according to claim 2, wherein the press-fitting section provided on the adjustment dial is in a form of a projection provided on an outer periphery of the adjustment dial contacting the locking section of the external case.

4. The thermal overload relay according to claim 2, wherein the locking section provided on the external case is in a form of a chambered section.

5. The thermal overload relay according to claim 3, wherein the projection provided on the external case is provided around the entire outer periphery.

6. The thermal overload relay according to claim 3, wherein the press-fitting section of the adjustment dial includes at least three projections spaced at equal intervals on the outer periphery thereof.

7. The thermal overload relay according to claim 2, wherein the adjustment dial insertion hole has a triangular shape, and includes an adjustment dial contact surface in a form of a locking section provided on the external case.

8. The thermal overload relay according to claim 7, wherein the adjustment dial has a shaft section having a size sufficient to contact the adjustment dial contact surface so that the shaft section contacts the adjustment dial contact surface.

9. The thermal overload relay according to claim 1, wherein the press-fitting section is provided around the adjustment dial insertion hole, and the locking section is formed at a shaft of the adjustment dial.

10. The thermal overload relay according to claim 9, wherein the press-fitting section is a projection, and the locking section is a groove or projection formed at the shaft and engaging the projection.
